(19) United States
(12) Patent Application Publication
(10) Pub. No.: US 2022/0300719 A1
(43) Pub. Date: Sep. 22, 2022

(54) SYSTEM AND METHOD FOR GENERATING MULTILINGUAL TRANSCRIPT FROM MULTILINGUAL AUDIO INPUT

(71) Applicant: Gnani Innovations Private Limited, Bengaluru (IN)

(72) Inventor: Vishay RAINA, Jammu (IN)

(21) Appl. No.: 17/570,786

(22) Filed: Jan. 7, 2022

(30) Foreign Application Priority Data
Mar. 16, 2021 (IN) 202141011026

(51) Int. Cl. G06F 40/58; G10L 15/02; G10L 15/183; G10L 25/24; G10L 15/22

(52) U.S. Cl. CPC G06F 40/58; G10L 15/02; G10L 15/183; G10L 25/24; G10L 15/22

(57) ABSTRACT

The present disclosure relates to a system for generating a multilingual transcript from a multilingual audio input. The system includes a processor being configured receive, from a source, a set of first signals pertaining to the multilingual audio input. Extract, based on the set of first signals, one or more attributes of the multilingual audio input, and correspondingly generate a set of second signals. Convert, based on the set of second signals, the multilingual audio input in to a plurality of monolingual transcripts having respective plurality of segments. The plurality of segments is associated with a plurality of languages present in the multilingual audio input. Generate, using machine learning technique, the multilingual transcript from the plurality of monolingual text outputs. The transcript comprises the one or more segments from each of the plurality of segments associated with the plurality of monolingual transcript.

### TECHNICAL FIELD

The present disclosure relates to the field of speech to text conversion. More particularly the present disclosure relates to the generating a mixed code transcript using monolingual ASRs.

### BACKGROUND

Background description includes information that may be useful in understanding the present invention. It is not an admission that any of the information provided herein is prior art or relevant to the presently claimed invention, or that any publication specifically or implicitly referenced is prior art.

Conventionally, automatic speech recognition (ASR) is used to convert a speech or audible data in to a written data or a transcript. Generally, the monolingual ASRs are used to convert the speech data into a transcript in a single language. But sometimes the speech input can be a multilingual that means the speech data can include more than one language. In that case the conversion of the multilingual speech data into corresponding multilingual transcript is a computation and resource intensive.

There is, therefore, a need of a system or method that can generate a multilingual transcript corresponding to a multilingual speech data in a cost effective and efficient way.

### OBJECTS OF THE PRESENT DISCLOSURE

Some of the objects of the present disclosure, which at least one embodiment herein satisfies are as listed herein below.

It is an object of the present disclosure to provide a system or method that can generate a multilingual transcript corresponding to a multilingual speech data which is cost effective.

It is an object of the present disclosure to provide a system or method that can generate a multilingual transcript corresponding to a multilingual speech data which is less computation intensive.

It is an object of the present disclosure to provide a system or method that can generate a multilingual transcript corresponding to a multilingual speech data which is more efficient.

It is an object of the present disclosure to provide a system or method that can generate a multilingual transcript corresponding to a multilingual speech data using monolingual ASRs.

### SUMMARY

The present disclosure relates to the field of speech to text conversion. More particularly the present disclosure relates to the generating a mixed code transcript using monolingual ASRs.

An aspect of the present disclosure pertains to a system for generating a multilingual transcript from a multilingual audio input. The system includes a processor being configured to execute a set of instructions stored in a memory, which on execution, causes the system to receive, from a source, a set of first signals pertaining to the multilingual audio input. Extract, based on the set of first signals, one or more attributes of the multilingual audio input, and correspondingly generate a set of second signals. Convert, based on the set of second signals, the multilingual audio input in to a plurality of monolingual transcripts having respective plurality of segments. The plurality of segments are associated with a plurality of languages present in the multilingual audio input. Generate, using machine learning technique, the multilingual transcript from the plurality of monolingual text outputs. The transcript comprises the one or more segments from each of the plurality of segments associated with the plurality of monolingual transcript.

In an aspect, the generation of the multilingual transcript may include sequentially comparing, using a pre-defined technique, corresponding segments of the plurality of segments of the each of the monolingual transcript, to facilitate selection of a set of segments for the multilingual transcripts. The comparing may start from a first segment of all the plurality of segments associated with each of the monolingual transcripts. The one or more attributes may include Mel-frequency cepstral coefficients. Conversion of the multilingual audio input in to the plurality of monolingual transcripts may be performed by a plurality of monolingual automatic speech recognition modules (ASRs). The plurality of segments may include an information corresponding to any or combination of words, and letters of the multilingual audio input.

Yet another aspect of the present disclosure pertains to a method for generating a multilingual transcript from a multilingual audio input. The method includes receiving, from a source, a set of first signals pertaining to the multilingual audio input. Extracting, based on the set of first signals, one or more attributes of the multilingual audio input, and correspondingly generate a set of second signals. Converting, based on the set of second signals, the multilingual audio input in to a plurality of monolingual transcripts. The plurality of monolingual transcripts is associated with a plurality of languages present in the multilingual audio input. Generating, using machine learning technique, the multilingual transcript corresponding to the plurality of monolingual transcripts. The multilingual transcript comprises the one or more segments from each of the plurality of monolingual transcripts.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary module diagram of a system for generating multilingual transcript from a multilingual audio input, in accordance with an embodiment of the present disclosure.

FIG. 2 illustrates an exemplary flowchart representing various events involved in generating the bilingual transcript from a bilingual audio input, in accordance with an embodiment of the present disclosure.

FIG. 3 illustrates an exemplary method for generating the multilingual transcript, in accordance with an embodiment of the present disclosure.

FIG. 4 illustrates an exemplary computer system in which or with which embodiments of the present invention can be utilized, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

The present disclosure relates to the field of speech to text conversion. More particularly the present disclosure relates to the generating a mixed code transcript using monolingual ASRs.

An embodiment of the present disclosure pertains to a system for generating a multilingual transcript from a multilingual audio input. The system includes a processor being configured to execute a set of instructions stored in a memory, which on execution, causes the system to receive, from a source, a set of first signals pertaining to the multilingual audio input. Extract, based on the set of first signals, one or more attributes of the multilingual audio input, and correspondingly generate a set of second signals. Convert, based on the set of second signals, the multilingual audio input in to a plurality of monolingual transcripts having respective plurality of segments. The plurality of segments are associated with a plurality of languages present in the multilingual audio input. Generate, using machine learning technique, the multilingual transcript from the plurality of monolingual text outputs. The transcript comprises the one or more segments from each of the plurality of segments associated with the plurality of monolingual transcript.

In an embodiment, the generation of the multilingual transcript can include sequentially comparing, using a pre-defined technique, corresponding segments of the plurality of segments of the each of the monolingual transcript, to facilitate selection of a set of segments for the multilingual transcripts.

In an embodiment, the comparing can start from a first segment of all the plurality of segments associated with each of the plurality of monolingual transcript.

In an embodiment, the one or more attributes can include Mel-frequency cepstral coefficients.

In an embodiment, conversion of the multilingual audio input in to the plurality of monolingual transcript can be performed by a plurality of monolingual automatic speech recognition modules (ASRs).

In an embodiment, the plurality of segments can include an information corresponding to any or combination of words, and letters of the multilingual audio input.

Yet another embodiment elaborates upon a method for generating a multilingual transcript from a multilingual audio input. The method includes receiving, from a source, a set of first signals pertaining to the multilingual audio input. Extracting, based on the set of first signals, one or more attributes of the multilingual audio input, and correspondingly generate a set of second signals. Converting, based on the set of second signals, the multilingual audio input in to a plurality of monolingual transcripts. The plurality of monolingual transcripts is associated with a plurality of languages present in the multilingual audio input. Generating, using machine learning technique, the multilingual transcript corresponding to the plurality of monolingual transcripts. The multilingual transcript comprises the one or more segments from each of the plurality of monolingual transcripts.

In an embodiment, the generation of the multilingual transcript can include sequentially comparing, using a pre-defined technique, corresponding segments of the plurality of segments of the each of the monolingual transcript, to facilitate selection of a set of segments for the multilingual transcripts.

In an embodiment, the comparing can start from a first segment of all the plurality of segments associated with each of the plurality of monolingual transcript.

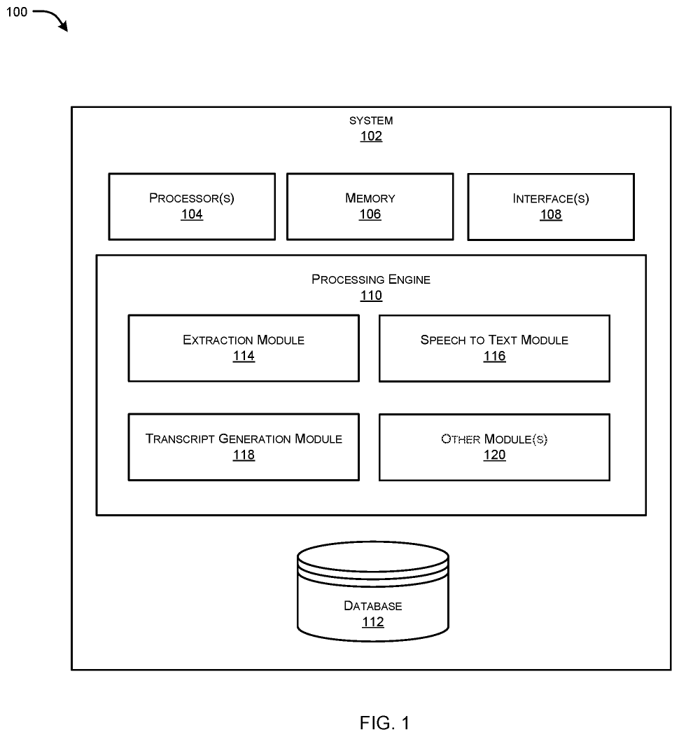

FIG. 1 illustrates an exemplary module diagram of a system for generating multilingual transcript from a multilingual audio input, in accordance with an embodiment of the present disclosure.

As illustrated, a system 102 for generating a multilingual transcript from a multilingual audio can be configured with an audio source (also referred as source, herein). The audio source can be configured to generate a multilingual audio (also referred as multilingual audio input). The multilingual audio can be referred to an audio having multiples languages such as a sentence containing English and Hindi both. The multilingual transcript can be referred to a text output, corresponding to the multilingual audio input. The text output can be in the form of a sentence having different words in different languages as they were originally in the multilingual audio input. The system can include one or more processor(s) 104. The one or more processor(s) 104 may be implemented as one or more microprocessors, microcomputers, microcontrollers, digital signal processors, central processing units, logic circuitries, and/or any devices that manipulate data based on operational instructions. Among other capabilities, the one or more processor(s) 104 are configured to fetch and execute computer-readable instructions stored in a memory 106 of the system 102. The memory 106 may store one or more computer-readable instructions or routines, which may be fetched and executed to create or share the data units over a network service. The memory 106 may comprise any non-transitory storage device including, for example, volatile memory such as RAM, or non-volatile memory such as EPROM, flash memory, and the like.

The system 102 may also comprise an interface(s) 108. The interface(s) 108 may comprise a variety of interfaces, for example, interfaces for data input and output devices, referred to as I/O devices, storage devices, and the like. The interface(s) 108 may facilitate communication of system 102. The interface(s) 108 may also provide a communication pathway for one or more components of the system 102. Examples of such components include, but are not limited to, processing engine(s) 110 and data 112.

The processing engine(s) 110 may be implemented as a combination of hardware and programming (for example, programmable instructions) to implement one or more functionalities of the processing engine(s) 110. In examples described herein, such combinations of hardware and programming may be implemented in several different ways. For example, the programming for the processing engine(s) 110 may be processor executable instructions stored on a non-transitory machine-readable storage medium and the hardware for the processing engine(s) 110 may comprise a processing resource (for example, one or more processors), to execute such instructions. In the present examples, the machine-readable storage medium may store instructions that, when executed by the processing resource, implement the processing engine(s) 110. In such examples, the system 102 may comprise the machine-readable storage medium storing the instructions and the processing resource to execute the instructions, or the machine-readable storage medium may be separate but accessible to system 102 and the processing resource. In other examples, the processing engine(s) 110 may be implemented by electronic circuitry.

The data 112 may comprise data that is either stored or generated as a result of functionalities implemented by any of the components of the processing engine(s) 110 or the system 102. The multilingual audio input can be received by the system 102 through a receiving module 114. The received multilingual audio input, in the form of set of first signals, can be inputted to an extraction module 116 that can be configured to extract one or more attribute of the multilingual audio input. The one or more attributes of the multilingual audio can comprise but not limited to Mel-frequency cepstral coefficients (MFCC) and can correspondingly generate a set of second signals.

In an embodiment, the set of second signals can be received by a speech to text conversion module 118 that can be configured to convert the multilingual audio input into a plurality of monolingual transcript on the basis of the one or more attributes of the multilingual audio input and correspondingly generate a set of third signals. The monolingual transcript can be referred to a sentence having multiple words in a same language. Each of the plurality of monolingual transcripts can include a respective plurality of segments. The plurality of segments is associated with a plurality of languages present in the multilingual audio input. The plurality of segments can comprise an information corresponding to but not limited to words, and letters of the multilingual audio input.

In an embodiment, the plurality of monolingual transcripts from the plurality of the ASR can be received by a multilingual transcript generation module 118 that can be configured to generate the transcript containing a set of segments from each of the plurality of segments associated with the plurality of monolingual transcripts. The generation of the monolingual transcripts. The generation of multilingual transcripts can include sequentially comparing, using a pre-defined technique, corresponding segments of the plurality of segments of the each of the monolingual transcript, to facilitate selection of a set of segments for the multilingual transcripts. The comparing can start from a first segment of all the plurality of segments associated with each of the plurality of monolingual transcript. The pre-defined technique can include statistical and probabilistic technique to determine the probability of a given sequence of words occurring in a sentence.

In an embodiment, the language model can be associated with a comprehensive dictionary of every language. The language model can compare the first segments of the plurality of segments associated with each of the monolingual transcript in the dictionary to finally select a final first segment for the multilingual transcript. Same steps can be used to complete the multilingual transcript from the plurality of monolingual transcript.

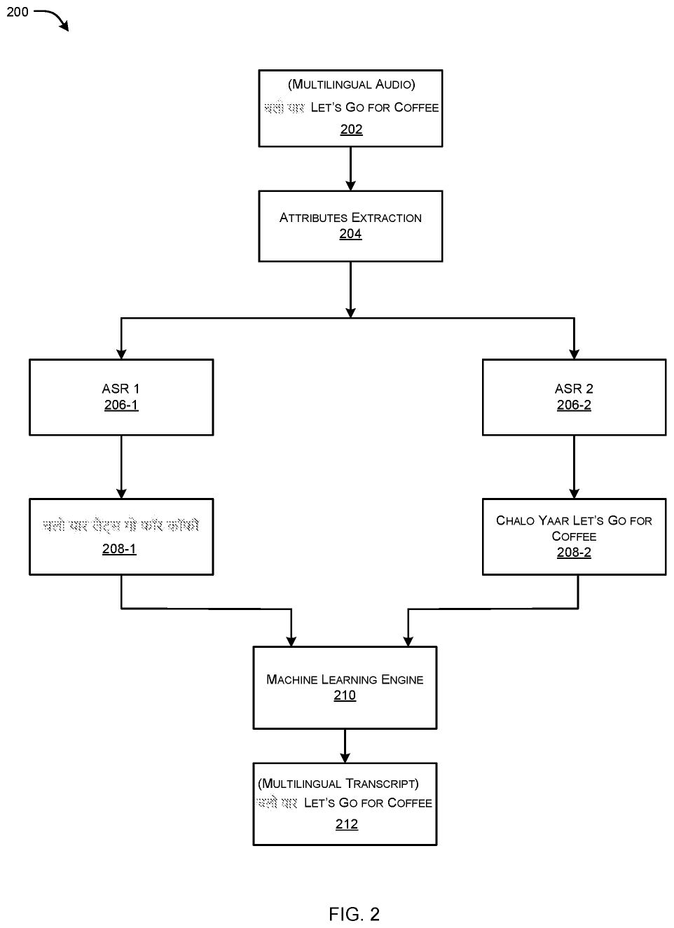

FIG. 2 illustrates an exemplary flowchart representing various events involved in generating the bilingual transcript from a bilingual audio input, in accordance with an embodiment of the present disclosure.

As illustrated, in an example, a multilingual audio input 202 contains two languages such as English and Hindi can be received by the system 102. The audio source can be configured with the system through but without limiting to through wired, and wireless configuration. The system 102 can be configured to extract the MFCC values 204 (also referred as attributes extraction 204, herein) of the bilingual audio input 202. The MFCC values 204 of the bilingual audio input 202 can be inputted to the two ASRs 206 (also referred as speech to text module, herein) that can convert the bilingual audio inputs into two monolingual text transcripts. First ASR 206-1 (ASR1) can generate a first English transcript 208-1 corresponding to the bilingual audio input 202 and a second ASR 206-2 (ASR2) can generate a second Hindi transcript 208-2 corresponding to the bilingual audio input 202. The first and second transcripts (208-1, 208-2) can be referred as the plurality of monolingual transcripts. The first transcript 208-1 can include all words in English and the second transcript 208-2 can include all words in Hindi for this case, as there are Hindi and English words in the bilingual audio input 202.

In an embodiment, a machine learning (ML) engine 201 can be configured to receive the first transcript 208-1 and the second transcript 208-2. The machine learning engine 210 can perform a sequence-to-sequence mapping of both the first and second transcripts (208-1, 208-2) using a language model to generate the multilingual transcript 212 corresponding to the first transcript 208-1 and the second transcript 208-2. The ML engine 210 can compare the corresponding words in the first and second transcript with the dictionary to identify an authentic language of the words (or segments) in the first and second transcript (208-1, 208-2), to select set of words (or segments) for the multilingual transcript 212. For example, if one or the plurality of segments of each of the first and second transcript (208-1, 208-2) is “GO” then the ML engine 210 can identify that the word “GO” is an English word and correspondingly select word “GO” in English language, for the multilingual transcript 212. Same steps can be performed for identify the set of words (or segments) for the multilingual transcript 212. Further, the ML engine 210 can suggest following segments of the multilingual transcript 212 one at least one of the set of segments of the multilingual transcript is identified. The suggestion can include but without limiting to any or combination of next word, and next word language.

In an embodiment, the ML engine 201 can map two or more different length monolingual transcriptions to a single multilingual transcript. The ML engine 201 can include fixed vocabulary, containing word-pieces or alphabets (also referred as segments, herein) from all the languages, and also <blank> symbol for null output. The ML engine 201 can include a prediction network, that can classify the monolingual transcripts in a sequential manner, and a suggestion network, that can predict next word-piece, given a previous word piece is already selected. The multilingual transcript can be generated with the help of a combination of the prediction network and the suggestion network, collectively referred as the ML engine 201. This can exploit the sequential as well as contextual information in the monolingual transcripts to produce a high-quality multilingual code switching transcript.

In another example, if a multilingual audio input is “Yo fui a la store to buy las uvas”, and a first monolingual transcript generated is “Y o fui a la es toy buenos las uvas” and a second monolingual transcript is “Your few alan store to buy las was”. In this case length of both the first and second monolingual transcript are different and the ML engine 201 can add <blank> symbol to the second monolingual transcript to make the length same. First “Y” of the first monolingual transcript and “Your” of the second monolingual transcript can be compared and “Your” can be selected. For next word “o” can be compare with “few”, in this second comparison the proposed system will refer the first word and will select the next word as “Few” since the first selected word is “Your” and it makes sense of selecting “few” instead of “o”. Also, a better second word can be selected from dictionary in order to complete multilingual transcript. In this way the complete sentence for multilingual transcript can selected.

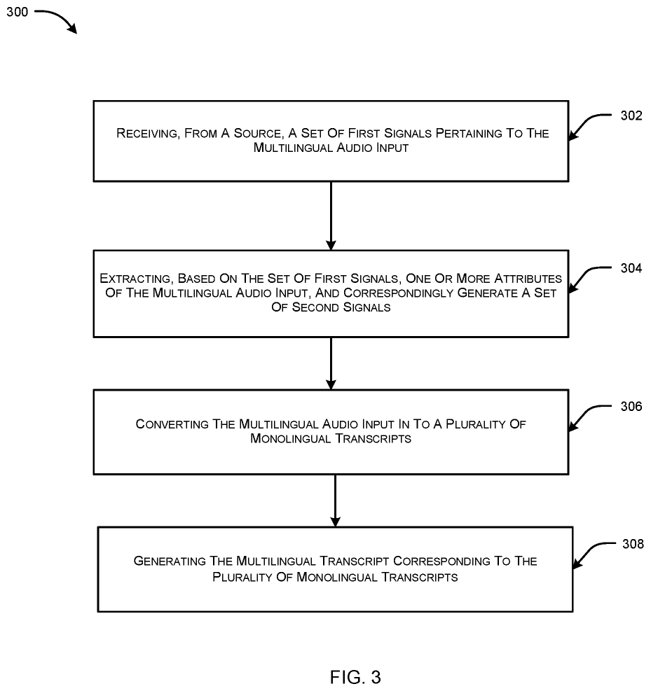

FIG. 3 illustrates an exemplary method for generating the multilingual transcript, in accordance with an embodiment of the present disclosure.

As illustrated, at step 302, a method 300 for generating a multilingual transcript from a multilingual audio input can include receiving, from a source, a set of first signals pertaining to the multilingual audio input.

In an embodiment, at step 304, the method 300 can include extracting, based on the set of first signals, one or more attributes of the multilingual audio input, and correspondingly generate a set of second signals.

In an embodiment, at step 306, the method 300 can include converting, based on the set of second signals, the multilingual audio input in to a plurality of monolingual transcripts. The plurality of monolingual transcripts is associated with a plurality of languages present in the multilingual audio input.

In an embodiment, at step 308, the method 300 can include generating, using machine learning technique, the multilingual transcript corresponding to the plurality of monolingual transcripts. The multilingual transcript comprises the one or more segments from each of the plurality of monolingual transcripts.

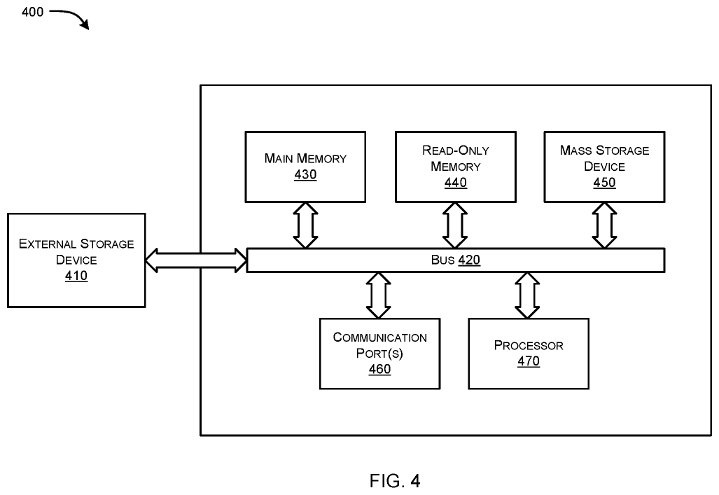

FIG. 4 illustrates an exemplary computer system in which or with which embodiments of the present invention can be utilized, in accordance with embodiments of the present disclosure.

Computer system 400 can include an external storage device 410, a bus 420, a main memory 430, a read only memory 440, a mass storage device 450, communication port 460, and a processor 470. A person skilled in the art will appreciate that the computer system may include more than one processor and communication ports. Examples of processor 470 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 470 may include various modules associated with embodiments of the present invention. Communication port 460 can be any of an RS-232 port for use with a modem-based dialup connection, a 10/100 Ethernet port, a Gigabit or 10 Gigabit port using copper or fiber, a serial port, a parallel port, or other existing or future ports. Communication port 460 may be chosen depending on a network, such a Local Area Network (LAN), Wide Area Network (WAN), or any network to which computer system connects.

Memory 430 can be Random Access Memory (RAM), or any other dynamic storage device commonly known in the art. Read-only memory 440 can be any static storage device(s) e.g., but not limited to, a Programmable Read Only Memory (PROM) chips for storing static information e.g., start-up or BIOS instructions for processor 470. Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 420 communicatively couple processor(s) 470 with the other memory, storage and communication blocks. Bus 420 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 470 to software system.

Optionally, operator and administrative interfaces, e.g. a display, keyboard, and a cursor control device, may also be coupled to bus 420 to support direct operator interaction with a computer system. Other operator and administrative interfaces can be provided through network connections connected through communication port 460. The external storage device 410 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The proposed invention provides a system or method that can generate a multilingual transcript corresponding to a multilingual speech data which is cost effective.

The proposed invention provides a system or method that can generate a multilingual transcript corresponding to a multilingual speech data which is less computation intensive.

The proposed invention provides a system or method that can generate a multilingual transcript corresponding to a multilingual speech data which is more efficient.

The proposed invention provides a system or method that can generate a multilingual transcript corresponding to a multilingual speech data using monolingual ASRs.

We claim:

1. A system for generating a multilingual transcript from a multilingual audio input, the system comprising:
a processor being configured to execute a set of instructions stored in a memory, which on execution, causes the system to:
receive, from a source, a set of first signals pertaining to the multilingual audio input;
extract, based on the set of first signals, one or more attributes of the multilingual audio input, and correspondingly generate a set of second signals;
convert, based on the set of second signals, the multilingual audio input in to a plurality of monolingual transcripts having respective plurality of segments, wherein the plurality of monolingual transcripts is associated with a plurality of languages present in the multilingual audio input; and
generate, using machine learning technique, the multilingual transcript corresponding to the plurality of monolingual transcripts, wherein the multilingual transcript comprises the one or more segments from each of the plurality of segments associated with the plurality of monolingual transcripts.

2. The system as claimed in claim 1, wherein the generation of the multilingual transcript comprises:
sequentially comparing, using a pre-defined technique, corresponding segments of the plurality of segments of the each of the monolingual transcript, to facilitate selection of a set of segments for the multilingual transcripts.

3. The system as claimed in claim 2, wherein the comparing starts from a first segment of all the plurality of segments associated with each of the plurality of monolingual transcript.

4. The system as claimed in claim 1, wherein the one or more attributes comprise Mel-frequency cepstral coefficients.

5. The system as claimed in claim 1, wherein conversion of the multilingual audio input in to the plurality of monolingual transcripts is performed by a plurality of monolingual automatic speech recognition modules (ASRs).

6. The system as claimed in claim 1, wherein the plurality of segments comprises an information corresponding to any or combination of words, and letters.

7. A method for generating a transcript from a multilingual audio input, the method comprising:
receiving, from a source, a set of first signals pertaining to the multilingual audio input;
extracting, based on the set of first signals, one or more attributes of the multilingual audio input, and correspondingly generate a set of second signals;
converting, based on the set of second signals, the multilingual audio input in to a plurality of monolingual transcripts, wherein the plurality of monolingual transcripts is associated with a plurality of languages present in the multilingual audio input; and
generating, using machine learning technique, the multilingual transcript corresponding to the plurality of monolingual transcripts, wherein the multilingual transcript comprises the one or more segments from each of the plurality of monolingual transcripts.

8. The method as claimed in claim 7, wherein the generation of the multilingual transcript comprises:
sequentially comparing, using a pre-defined technique, corresponding segments of the plurality of segments of the each of the monolingual transcript, to facilitate selection of a set of segments for the multilingual transcripts.

9. The method as claimed in claim 8, wherein the comparing starts from a first segment of all the plurality of segments associated with each of the plurality of monolingual transcript.
